(19) United States
(12) Patent Application Publication
(10) Pub. No.: US 2026/0195278 A1
(43) Pub. Date: Jul. 9, 2026

(54) MONITORING DATA STORAGE DRIVE PERFORMANCE USING AN ARTIFICIAL NEURAL NETWORK

(71) Applicant: Dell Products L.P., Round Rock, TX (US)

(72) Inventors: Baote Zhuo, Beijing (CN); Vamsi K. Vankamamidi, Hopkinton, MA (US); Geng Han, Beijing (CN)

(21) Appl. No.: 19/009,128

(22) Filed: Jan. 3, 2025

(51) Int. Cl. G06F 13/16; G06F 11/07

(52) U.S. Cl. CPC G06F 13/1689; G06F 11/0745; G06F 11/0793

(57) ABSTRACT

At least one I/O request is received that is directed to a data storage device, and an artificial neural network corresponding to a type of the data storage device is selected. The artificial neural network generates a predicted response time for processing the I/O request using the storage device. The artificial neural network may be trained offline using a training storage device of the same type as the storage device to which the I/O request is directed. An actual response time of processing the I/O request may be compared to the predicted response time, and a corrective action performed in response to the actual response time exceeding the predicted response time by at least a predetermined threshold.

### TECHNICAL FIELD

This disclosure relates generally to monitoring data storage drive performance, and more specifically to technology for monitoring performance of an individual data storage drive performance using an artificial neural network corresponding to the type of the data storage drive.

### BACKGROUND

Data storage systems include one or more physical or virtual data storage nodes that are made up of hardware and/or software, and that service host I/O requests received from physical and/or virtual host machines (“hosts”). Host I/O requests received by a node specify user data that is written and/or read by the hosts. The storage node executes software that processes the host I/O requests by performing various data processing tasks to organize and persistently store the user data in non-volatile data storage.

In order to operate efficiently, a data storage system may need to monitor the performance of the data storage devices that it uses to persistently store user data.

### SUMMARY

In the disclosed technology, at least one I/O request is received that is directed to a data storage device. An artificial neural network is selected that corresponds to a type of the data storage device. The artificial neural network generates a predicted response time for processing the I/O request using the data storage device.

In some embodiments the artificial neural network is a deep neural network that is trained offline using a training data storage device of the same type as the data storage device to which the I/O request is directed.

In some embodiments, the training is performed using a sample set collected using the training data storage device of the same type as the data storage device to which the I/O request is directed.

In some embodiments, the artificial neural network is a three layer deep neural network having two hidden layers.

In some embodiments, an actual response time of processing the I/O request is measured, and the actual response time is compared to the predicted response time. A corrective action is performed in response to the actual response time exceeding the predicted response time by at least a predetermined threshold.

In some embodiments, the corrective action includes moving data currently stored on the data storage device to at least one other data storage device.

In some embodiments, the artificial neural network is selected from a set of multiple artificial neural networks based on the type of the data storage device to which the I/O request is directed. Each one of the artificial neural networks in the set of multiple artificial neural networks is trained to predict response times of I/O requests directed to data storage devices of an individual type.

The disclosed technology is integral to a technical solution to the problem of monitoring performance of data storage devices. In systems without the disclosed technology, user data may be evenly distributed across all data storage devices. Systems without the disclosed technology are less able to adapt their operation based on an accurate assessment of the performance of individual data storage devices. The disclosed technology avoids inaccurate performance assessments that systems without the disclosed technology may make, such as an assessment of high response times for a data storage device based on a relatively high response times resulting from a relatively high current workload, and that is unrelated to the inherent capabilities of the individual device.

The foregoing summary does not indicate required elements, or otherwise limit the embodiments of the disclosed technology described herein. The technical features described herein can be combined in any specific manner, and all combinations may be used to embody the disclosed technology.

### BRIEF DESCRIPTION OF THE DRAWINGS

The objects, features and advantages of the disclosed technology will be apparent from the following description of embodiments, as illustrated in the accompanying drawings in which like reference numbers refer to the same parts throughout the different views. The drawings are not necessarily to scale, emphasis instead being placed on illustrating the principles of the disclosed technology.

FIG. 1 is a block diagram showing an example of a data storage system in which an embodiment of the disclosed technology is provided;

FIG. 2 is a block diagram showing an example of an offline data storage system in some embodiments;

FIG. 3 is a block diagram illustrating the structure of an artificial neural network in some embodiments; and

FIG. 4 is a flow chart showing an example of steps performed in some embodiments.

### DETAILED DESCRIPTION

Embodiments will now be described with reference to the figures. The embodiments described herein are provided only as examples, in order to illustrate various features and principles of the disclosed technology and are not limiting. The embodiments of the disclosed technology described herein are integrated into a practical solution for accurate monitoring of the performance of individual data storage devices.

The disclosed technology receives at least one I/O request that is directed to a data storage device and selects an artificial neural network that corresponds to a type of the data storage device. The artificial neural network generates a predicted response time for processing the I/O request using the storage device. The artificial neural network may be a deep neural network that is trained offline using a training storage device of the same type as the storage device to which the I/O request is directed. The training may be performed using a sample set collected using the training storage device of the same type as the storage device. The artificial neural network may, for example, be a three layer deep neural network having two hidden layers.

The disclosed technology may measure an actual response time of processing the I/O request and compare the actual response time to the predicted response time. A corrective action is performed in response to the actual response time exceeding the predicted response time by at least a predetermined threshold. The corrective action may include moving data that is currently stored on the data storage device to at least one other data storage device.

The artificial neural network may be selected from a set of multiple artificial neural networks based on the type of the data storage device to which the I/O request is directed. Each one of the artificial neural networks in the set of multiple artificial neural networks is trained to predict response times of I/O requests directed to data storage devices of an individual type.

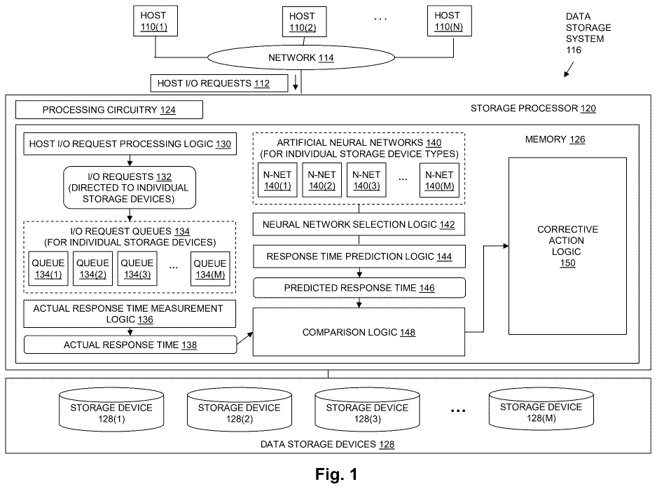

FIG. 1 is a block diagram showing an example of a data storage system in which the disclosed technology is embodied. FIG. 1 shows a number of physical and/or virtual Host Computing Devices 110, referred to as “hosts”, and shown for purposes of illustration by Hosts 110(1) through 110(N). The hosts and/or applications executing thereon access non-volatile data storage served by Data Storage System 116, for example over one or more networks, such as a local area network (LAN), and/or a wide area network (WAN) such as the Internet, etc., and shown for purposes of illustration in FIG. 1 by Network 114. Alternatively, or in addition, one or more of Hosts 110 and/or applications accessing non-volatile data storage provided by Data Storage System 116 may execute within Data Storage System 116.

Data Storage System 116 includes at least one Storage Processor 120 that is communicably coupled to both Network 114 and Data Storage Devices 128, e.g. though one or more communication interfaces. No particular hardware configuration is required, and Storage Processor 120 may be embodied as any specific type of device that is capable of processing host input/output (I/O) requests (e.g. I/O read requests and I/O write requests, etc.) and persistently storing host data.

Data Storage Devices 128 includes M physical non-volatile data storage devices such as solid-state drives, magnetic disk drives, hybrid drives, optical drives, and/or other specific types of drives, shown for purposes of illustration by Storage Device 128(1), Storage Device 128(2), Storage Device 128(3), and so on through Storage Device 128(M). Each individual one of the data storage devices in Data Storage Devices 128 has a corresponding type that represents or consists of i) the manufacturer of the data storage device and ii) a model number of the data storage device. For purposes of explanation, each one of the data storage devices in Data Storage Devices 128 has a different type, e.g. Storage Device 128(1) is a data storage device of a first type, Storage Device 128(2) is a data storage device of a second type, Storage Device 128(3) is a data storage device of a third type, and so on.

Memory 126 stores program code that is executed on Processing Circuitry 124, as well as data generated and/or processed by such program code. Memory 126 may include volatile memory (e.g. RAM), and/or other types of memory.

Processing Circuitry 124 includes or consists of multiple processor cores, e.g. within one or more multi-core processor packages. Each processor core includes or consists of a separate processing unit, sometimes referred to as a Central Processing Unit (CPU), and is capable of independently executing instructions.

Processing Circuitry 124 and Memory 126 together form control circuitry that is configured and arranged to carry out various methods and functions described herein. Memory 126 stores a variety of software components that may be provided in the form of executable program code. For example, Memory 126 may include software components such as Host I/O Request Processing Logic 130, Actual Response Time Measurement Logic 136, Artificial Neural Networks 140, Neural Network Selection Logic 142, Response Time Prediction Logic 144, Comparison Logic 148, and Corrective Action Logic 150. When program code stored in Memory 126 is executed by Processing Circuitry 124, Processing Circuitry 124 is caused to carry out the operations of the software components described herein. Although certain software components are shown in the Figures and described herein for purposes of illustration and explanation, those skilled in the art will recognize that Memory 126 may also include various other specific types of software components.

Data Storage System 116 provides one or more data storage services to Hosts 110. Host I/O Requests 112 include host I/O write requests that indicate host data that is to be stored by Data Storage System 116 in Physical Non-Volatile Data Storage Drives 128. Examples of data storage protocols that may be supported by Data Storage System 116 include without limitation Fibre Channel (FC), Internet Small Computer Systems Interface (iSCSI), and/or Non-Volatile Memory Express (NVMe) protocols.

During operation of the components shown in FIG. 1, Host I/O Request Processing Logic 130 processes Host I/O Requests 112, and generates “backend” I/O Requests 132 that write host data to and/or read host data from the Data Storage Devices 128. Each I/O request in I/O Requests 132 is a read or write operation that is directed to an individual one of the data storage devices in Data Storage Devices 128. I/O Request Queues 134 includes multiple I/O request queues, each one of which corresponds to one of the data storage devices in Data Storage Devices 128. Queue 134(1) corresponds to Storage Device 128(1), Queue 134(2) corresponds to Storage Device 128(2), Queue 134(3) corresponds to Storage Device 128(3), and so on through Queue 134(M), which corresponds to Storage Device 128(M). Each I/O request queue receives and stores those I/O requests in I/O Requests 132 that are directed to the data storage device that it corresponds to until the enqueued I/O requests are performed. Accordingly, Queue 134(1) receives and stores I/O requests that are directed to Storage Device 128(1), Queue 134(2) receives and stores I/O requests that are directed to Storage Device 128(2), Queue 134(3) receives and stores I/O requests I/O requests that are directed to Storage Device 128(3), and so on through Queue 134(M), which receives and stores I/O requests that are directed to Storage Device 128(M).

Each one of the artificial neural networks in Artificial Neural Networks 140 corresponds to a specific type of data storage device, e.g. to a data storage device or devices in Data Storage Devices 128 that i) are from a specific manufacturer and ii) have a specific model number. Each artificial neural network in Artificial Neural Networks 140 is trained to predict response times of I/O requests directed to data storage devices of its corresponding type. Artificial Neural Networks 140 may include as many artificial neural networks as there are different types of data storage devices in Data Storage Devices 128. In the example where each one of the M data storage devices in Data Storage Devices 128 is a different type of data storage device, Artificial Neural Networks 140 includes M artificial neural networks, e.g. a Neural Network 140(1) that corresponds to a first data storage device type, Neural Network 140(2) corresponds to a second data storage device type, Neural Network 140(3) corresponds to a third data storage device type, and so on.

For each one of the I/O requests received into one of the I/O request queues in I/O Request Queues 132, Neural Network Selection Logic 142 selects the one of the artificial neural networks in Artificial Neural Networks 140 that corresponds to a data storage device type that is the same as the type of the data storage device to which the I/O request is directed. For example, in the case of an I/O request directed to Storage Device 128(1) and received in Queue 134(1), Neural Network Selection Logic 142 selects Neural Network 140(1), since Storage Device 128(1) is a data storage device of the first type, and Neural Network 140(1) corresponds to the first type of data storage device. Similarly, in the case of an I/O request directed to Storage Device 128(2) and received in Queue 134(2), Neural Network Selection Logic 142 selects Neural Network 140(2), since Storage Device 128(2) is a data storage device of the second type, and Neural Network 140(2) corresponds to the second type of data storage device.

For each I/O request, the artificial neural network selected by Neural Network Selection Logic 142 for the I/O request is then executed by Response Time Prediction Logic 144 to generate a Predicted Response Time 146 for processing the I/O request using the data storage device to which the I/O request is directed. For example, in the case of an I/O request directed to Storage Device 128(1) and received in Queue 134(1), Response Time Prediction Logic 144 uses Neural Network 140(1) to generate a Predicted Response Time 146 that is the predicted response time for processing the I/O request from the issuance of the I/O request to Storage Device 128(1) until completion of the I/O request. In the case of an I/O request directed to Storage Device 128(2) and received in Queue 134(2), Response Time Prediction Logic 144 uses Neural Network 140(2) to generate a Predicted Response Time 146 that is the predicted response time for processing the I/O request using Storage Device 128(2), and similarly for I/O requests directed to the other data storage devices in Data Storage Devices 128.

Each one of the artificial neural networks in Artificial Neural Networks 140 may be a deep neural network having multiple layers between its input and output layers. Each one of the artificial neural networks in Artificial Neural Networks 140 is trained offline prior to being deployed in Data Storage System 116 in a production environment. Each artificial neural network in Artificial Neural Networks 140 is trained using a training data storage device of the data storage device type corresponding to the artificial neural network. In this way, each artificial neural network is trained using a training data storage device of the same type as the data storage device to which are directed the I/O requests for which the artificial neural network is used to generate predicted response times. Accordingly, Neural Network 140(1) may be trained offline using a training data storage device of the first data storage device type, Neural Network 140(2) may be trained offline using a training data storage device of the second data storage device type, Neural Network 140(3) may be trained offline using a training data storage device of the third data storage device type, and so on for each of the neural networks in Artificial Neural Networks 140.

Actual Response Time Measurement Logic 136 measures an actual response time of processing each I/O request from issuance to the storage device until completion of the I/O request, as shown by Actual Response Time 138. For each I/O request, Comparison Logic 148 compares the Actual Response Time 138 measured for processing the I/O request to completion to the Predicted Response Time 146 that was generated for the same I/O request using one of the neural networks in Artificial Neural Networks 140. In response to detecting that the Actual Response Time 138 measured for one or more I/O requests exceeds the Predicted Response Time 146 by at least some predetermined threshold amount, Corrective Action Logic 150 performs a corrective action to attempt to reduce the amount of traffic directed to the data storage device to which the I/O request was directed. For example, in the case where the Actual Response Time 138 exceeds the Predicted Response Time 146 for one or more I/O requests that were directed to Storage Device 128(1) by at least a minimum amount, Corrective Action Logic 150 may move some amount of the host data previously stored on Storage Device 128(1) to another one of the data storage devices in Data Storage Devices 128. In such a case, the data storage device to which the host data is moved from Storage Device 128(1) may be another data storage device that is exhibiting actual response times for processing I/O requests that do not exceed its predicted response times, e.g. Storage Device 128(2) or some other one of the data storage devices in Data Storage Devices 128. Other corrective actions may be performed alternatively or in addition, such as redirecting future I/O requests directed to Storage Device 128(1) to other ones of the data storage devices in Data Storage Devices 128.

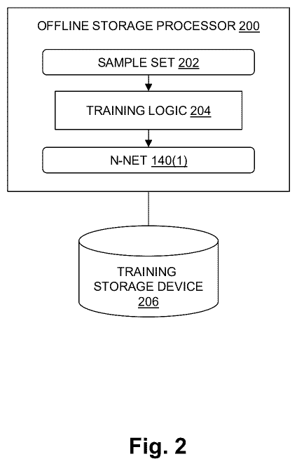

FIG. 2 is a block diagram showing an example of offline data storage system used to perform offline training in some embodiments. In the example of FIG. 2, Training Logic 204 executing in an Offline Storage Processor 200 trains Neural Network 140(1). Training Logic 204 trains Neural Network 140(1) using a training data storage device of the same type as Storage Device 128(1), e.g. Training Storage Device 206. Before the training is performed, a sample set of I/O requests is collected using Training Storage Device 206, e.g. Sample Set 202. Each sample in the sample set is a set of I/O requests. The number of I/O requests in each sample may be equal to a queue depth limit of the queue corresponding to the type of data storage device, e.g. to a queue depth limit for Queue 134(1). Each I/O request in a sample is a feature of the sample, and at least two attributes may be collected for each I/O request in a sample: I/O request type and I/O request size. These two attributes are sufficient for training with regard to solid state drives (SSDs), since SSDs are insensitive to whether I/O requests are sequential or random. For other types of data storage devices, a logical block address (LBA) of each I/O request may be collected as an additional attribute. The two types of I/O requests collected may be read I/O requests and write I/O requests, and various different sizes of I/O requests may be collected, e.g. 4 KB, 8 KB, . . . 2048 KB. The sample set is divided into two parts: a training set of samples and a test set of samples. The training set is used to train the parameters of the neural network, and the test set is used to test the accuracy of the trained neural network prior to deployment. The offline training may be performed using an L2 loss function as the loss function, a Rectified Linear Unit (ReLU) function as the activation function, and an Adam optimization algorithm as the gradient descent algorithm. Training Logic 204 repeats the forward propagation algorithm and backward propagation algorithm, until the amount of error is relatively small. Neural Network 140(1) can then be moved to the production environment of Storage Processor 120. Error measurement may be based on Root Mean Squared Error (RMSE). The forward propagation algorithm and backward propagation algorithm may be implemented using deep learning frameworks such as TensorFlow, Caffe/Caffe2, MxNet, etc.

In some embodiments, Sample Set 202 may be obtained using the Flexible I/O Tester (FIO) tool. For example, in an FIO script, the queue depth of the Training Storage Device 206 is 8, the I/O size is from 4 KB to 2 MB, and the read/write mix indicates a mixed workload in which the percentage of reads is from 0% to 100%.

While for purposes of explanation the above describes training of Neural Network 140(1), similar offline training is performed for each other one of the artificial neural networks in Artificial Neural Networks 140.

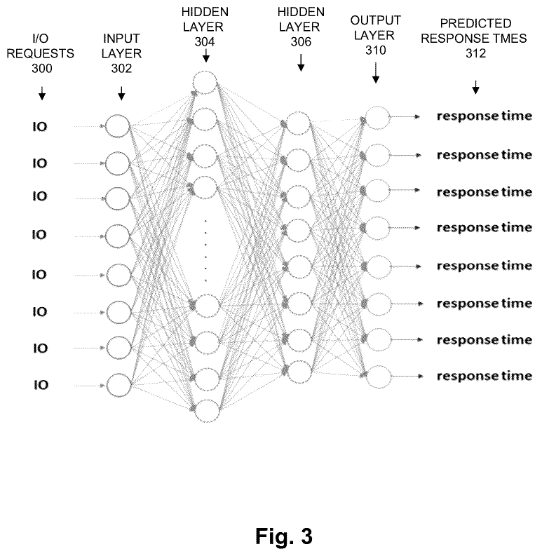

FIG. 3 is a block diagram showing an example of the structure of each of the neural networks in Artificial Neural Networks 140 in some embodiments. The neural network shown in FIG. 3 is a three layer deep neural network having two hidden layers, e.g. Hidden Layer 304 and Hidden Layer 306, and an output layer, e.g. Output Layer 310. The input layer Input Layer 302 is not counted in the total number of layers. In the example of FIG. 3, based on a maximum queue depth of 8, there are 8 units in the Input Layer 302. The first Hidden Layer 304 has 64 units, and the second Hidden Layer 306 has 8 units. In the production environment of Storage Processor 120, the input I/O requests shown in I/O requests 300 may be stacked as a vector, which is then passed to the Input Layer 302. The previously trained neural network outputs the predicted response times for processing the input I/O requests in Predicted Response Times 312.

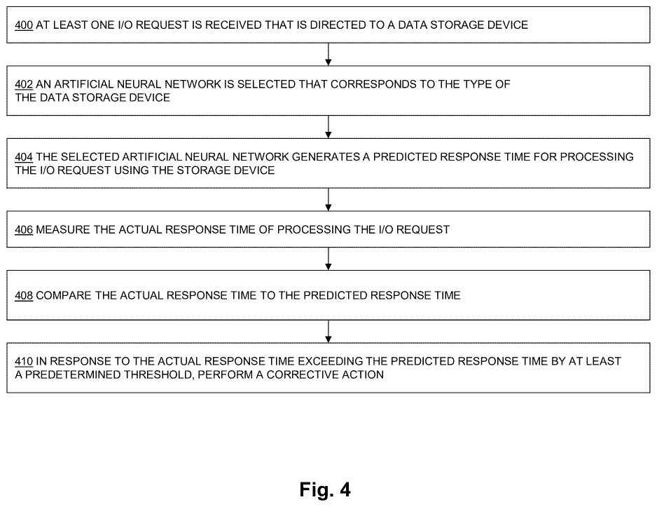

FIG. 4 is a flow chart showing an example of steps performed in some embodiments.

In step 400, at least one I/O request is received that is directed to a data storage device.

In step 402, an artificial neural network is selected that corresponds to the type of the data storage device.

In step 404, the selected artificial neural network generates a predicted response time for processing the I/O request using the storage device.

In step 406, the actual response time of processing the I/O request is measured.

In step 408, the actual response time is compared to the predicted response time.

In step 410, in response to the actual response time exceeding the predicted response time by at least a predetermined threshold amount, a corrective action is performed. For example, data stored on the data storage device may be moved to another data storage device.

As will be appreciated by those skilled in the art, aspects of the technologies disclosed herein may be embodied as a system, method or computer program product. Accordingly, each specific aspect of the present disclosure may be embodied using hardware, software (including firmware, resident software, micro-code, etc.) or a combination of software and hardware. Furthermore, aspects of the technologies disclosed herein may take the form of a computer program product embodied in one or more non-transitory computer readable storage medium(s) having computer readable program code stored thereon for causing a processor and/or computer system to carry out those aspects of the present disclosure.

Any combination of one or more computer readable storage medium(s) may be utilized. The computer readable storage medium may be, for example, but not limited to, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any non-transitory tangible medium that can contain or store a program for use by or in connection with an instruction execution system, apparatus, or device.

The figures include block diagram and flowchart illustrations of methods, apparatus(s) and computer program products according to one or more embodiments of the invention. It will be understood that each block in such figures, and combinations of these blocks, can be implemented by computer program instructions. These computer program instructions may be executed on processing circuitry to form specialized hardware. These computer program instructions may further be loaded onto programmable data processing apparatus to produce a machine, such that the instructions which execute on the programmable data processing apparatus create means for implementing the functions specified in the block or blocks. These computer program instructions may also be stored in a computer-readable memory that can direct a programmable data processing apparatus to function in a particular manner, such that the instructions stored in the computer-readable memory produce an article of manufacture including instruction means which implement the function specified in the block or blocks. The computer program instructions may also be loaded onto a programmable data processing apparatus to cause a series of operational steps to be performed on the programmable apparatus to produce a computer implemented process such that the instructions which execute on the programmable apparatus provide steps for implementing the functions specified in the block or blocks.

Those skilled in the art should also readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); or (b) information alterably stored on writable storage media (e.g. floppy disks and hard drives).

While the invention is described through the above exemplary embodiments, it will be understood by those of ordinary skill in the art that modification to and variation of the illustrated embodiments may be made without departing from the inventive concepts herein disclosed.

What is claimed is:

1. A method comprising:
receiving at least one I/O request directed to a data storage device;
selecting an artificial neural network corresponding to a type of the data storage device; and
generating, by the artificial neural network, a predicted response time for processing the I/O request using the data storage device.

2. The method of claim 1, wherein the artificial neural network comprises a deep neural network, and wherein the artificial neural network is trained offline using a training data storage device of the same type as the data storage device to which the I/O request is directed.

3. The method of claim 2, wherein the training is performed using a sample set collected using the training data storage device of the same type as the data storage device.

4. The method of claim 3, wherein the artificial neural network comprises a three layer deep neural network having two hidden layers.

5. The method of claim 4, further comprising:
measuring an actual response time of processing the I/O request;
comparing the actual response time to the predicted response time; and
in response to the actual response time exceeding the predicted response time by at least a predetermined threshold, performing a corrective action.

6. The method of claim 5, wherein the corrective action comprises moving data currently stored on the data storage device to at least one other data storage device.

7. The method of claim 5, further comprising:
selecting the artificial neural network from a plurality of artificial neural networks based on the type of the data storage device to which the I/O request is directed, wherein each one of the artificial neural networks in the plurality of artificial neural networks is trained to predict response times of I/O requests directed to data storage devices of an individual type.

8. A data storage system comprising:
processing circuitry and memory coupled to the processing circuitry, the memory storing instructions, wherein the instructions, when executed by the processing circuitry, cause the processing circuitry to:
receive at least one I/O request directed to a data storage device;
select an artificial neural network corresponding to a type of the data storage device; and
generate, by the artificial neural network, a predicted response time for processing the I/O request using the data storage device.

9. The data storage system of claim 8, wherein the artificial neural network comprises a deep neural network, and wherein the artificial neural network is trained offline using a training data storage device of the same type as the data storage device to which the I/O request is directed.

10. The data storage system of claim 9, wherein the training is performed using a sample set collected using the training data storage device of the same type as the data storage device.

11. The data storage system of claim 10, wherein the artificial neural network comprises a three layer deep neural network having two hidden layers.

12. The data storage system of claim 11, wherein the instructions, when executed by the processing circuitry, further cause the processing circuitry to:
measure an actual response time of processing the I/O request;
compare the actual response time to the predicted response time; and
perform a corrective action in response to the actual response time exceeding the predicted response time by at least a predetermined threshold amount.

13. The data storage system of claim 12, wherein the corrective action comprises moving data currently stored on the data storage device to at least one other data storage device.

14. The data storage system of claim 12, wherein the instructions, when executed by the processing circuitry, further cause the processing circuitry to:
select the artificial neural network from a plurality of artificial neural networks based on the type of the data storage device to which the I/O request is directed, wherein each one of the artificial neural networks in the plurality of artificial neural networks is trained to predict response times of I/O requests directed to data storage devices of an individual type.

15. A computer program product including a non-transitory computer readable medium having instructions stored thereon, wherein the instructions, when executed on processing circuitry, cause the processing circuitry to perform steps including:
receiving at least one I/O request directed to a data storage device;
selecting an artificial neural network corresponding to a type of the data storage device; and
generating, by the artificial neural network, a predicted response time for processing the I/O request using the data storage device.

16. The computer program product of claim 15, wherein the artificial neural network comprises a deep neural network, and wherein the artificial neural network is trained offline using a training data storage device of the same type as the data storage device to which the I/O request is directed.

17. The computer program product of claim 16, wherein the training is performed using a sample set collected using the training data storage device of the same type as the data storage device.

18. The computer program product of claim 17, wherein the artificial neural network comprises a three layer deep neural network having two hidden layers.

19. The computer program product of claim 18, wherein the steps further include:
measuring an actual response time of processing the I/O request;
comparing the actual response time to the predicted response time; and
in response to the actual response time exceeding the predicted response time by at least a predetermined threshold, performing a corrective action.

20. The computer program product of claim 19, wherein the corrective action comprises moving data currently stored on the data storage device to at least one other data storage device, and wherein the steps further include:
selecting the artificial neural network from a plurality of artificial neural networks based on the type of the data storage device to which the I/O request is directed, wherein each one of the artificial neural networks in the plurality of artificial neural networks is trained to predict response times of I/O requests directed to data storage devices of an individual type.
